(19) United States
(12) Patent Application Publication
(10) Pub. No.: US 2020/0286064 A1
(43) Pub. Date: Sep. 10, 2020

(54) INTELLIGENT CREDIT CARD UTILIZATION APPLICATION

(71) Applicant: Paul Lewis Regen, Felton, CA (US)

(72) Inventor: Paul Lewis Regen, Felton, CA (US)

(21) Appl. No.: 16/271,392

(22) Filed: Feb. 8, 2019

Related U.S. Application Data
(60) Provisional application No. 62/631,271, filed on Feb. 15, 2018.

(51) Int. Cl. G06Q 20/22; G06Q 40/02; G06Q 20/40; G06Q 20/34; G06Q 30/02; G06Q 20/10; G06Q 10/04; G06F 3/0482

(52) U.S. Cl. CPC G06Q 20/227; G06Q 40/025; G06Q 20/405; G06F 3/0482; G06Q 30/0233; G06Q 20/102; G06Q 10/04; G06Q 20/342

(57) ABSTRACT

The invention comprises various data points from various data sources to aid a user in selecting the proper credit card for a credit card transaction.

### CROSS-REFERENCE TO RELATED APPLICATIONS

This application claims priority to U.S. Provisional Application Ser. No. 62/631,271, filed on Feb. 15, 2018. U.S. Provisional Application is included herein at least by reference

### BACKGROUND OF THE INVENTION

### 1. Field of the Invention

The present invention is in the technical field of Financial Technology (FINTECH).

More particularly, the present invention is in the technical field of credit account Utilization and credit score optimization.

### 2. Discussion of the State of the Art

Since 1950, when the Credit Card was first invented, credit card users have been subject to a credit rating/score. Since then the credit scoring system has evolved to accommodate multiple credit cards and loan sources with various scoring methods. Managing and optimizing an individual's score has become more complex over the years resulting from consumers having available to them a plethora of credit resources. There is a pressing need for tools to help users have an overview and be able to manage their credit accounts in a much better way.

With the advent of smart phones and new smart credit card technologies a whole new field of opportunities has opened up in the world FINTECH. It will soon be possible to consolidate multiple credit card accounts and their related data into one universal digital card. The data will consist of credit card limits, interest rates, use of each card, mileage points, store credits, cash back, and any other relevant account information.

This type of consolidated information making it possible for consumers to better manage credit utilization and to optimize their credit scores though a strategic means using a set of weighted mathematical algorithms based on the user individual preferences. The present invention is designed to greatly enhance a user's ability to intelligently use their credit resources by helping them to make the best choice of which credit or debit card account to use based on their preselected criteria/preferences. The features provided in the invention are designed to enable the user to, Prioritize card selection based on preselected preferences, improve their credit score, to prompt user to make timely payments, and provide a means to easily make these payments.

What is clearly needed is an invention with the above characteristics comprising Computer Application hereafter “App” programmed and designed to run on smartphones, personal computers and any device that can support its operation with an underlying operating system and network connectivity.

### SUMMARY OF THE INVENTION

The invention discloses a system for choosing the right payment card during a transaction. In one embodiment a menu selection for a user to choose data that is automatically provided, user provided or manually entered data.

In another embodiment the user preferences may be at least one of, card priorities, score optimization, payment maximization, cash back, bill payment sources and GPS location on or off.

In one embodiment the auto entered data may be one of a credit limit, balance interest fees, cash back, airline points, gift cards, bill due dates, business or personal.

In one embodiment the manual entered data may be one of a credit limit, balance interest fees, cash back, airline points, gift credits, bill due dates, business or personal.

In one embodiment the auto entered data may be one of a credit limit, balance interest fees, cash back, airline points, gift cards, bill due dates, business or personal.

In one embodiment any of the automatically entered data, the user preferences data or the manual entered data may help the user select the right card for the purchase at the right time.

### BRIEF DESCRIPTION OF THE DRAWING FIGURES

FIG. 1 illustrates a user Perspective Flow Diagram is a perspective view of a flow chart of what the user will be involved in the process of setting up the App and using the App.

FIG. 2 is an illustration of an operations flow chart according to one embodiment of the invention

FIG. 3 illustrates special features according to one embodiment of the invention

FIG. 4 is an illustration of the platforms the app may run on according to one embodiment of the invention.

### DETAILED DESCRIPTION OF THE INVENTION

The applicant is an electrical and product development engineer working in the field of Financial Technology (FINTECH) it is applicant's opinion that there will soon be products on the market designed to consolidate multiple credit and debit cards into one card. The purpose of this data consolidation is to enable next generation credit/debit cards to become a one-card solution i.e., a universal credit/debit card.

At present, the user of a universal card is tasked with manually selecting the debit or credit card they want to use. With the ability to store from three to twenty-five or more credit and debit card accounts on one universal card, the task of managing these cards/accounts and particularly selecting the best one in a specific situation becomes a significant situation that most users don't have the expertise to deal with. This invention is a solution to this growing problem.

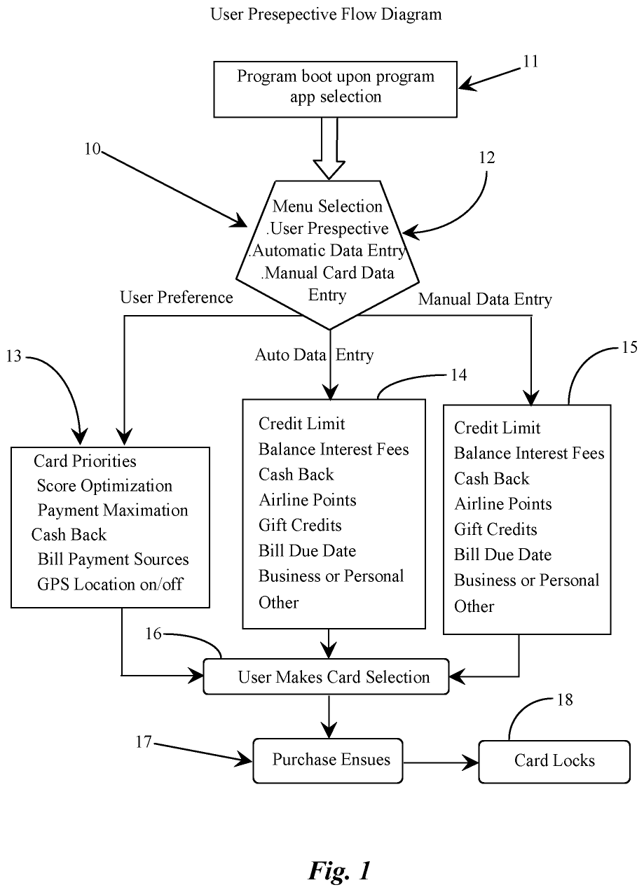

As the title states, “, Intelligent Credit Card Utilization Application,” implies, it is the function of the App program to aid the user in intelligently managing their card selection in accordance with their profile/preferences which they choose when they first use the App. In FIG. 1 is a User Perspective Flow Diagram 10 that shows how the logical flow of the App may operate. The App is booted into action 11 where it presents the user with a menu 12 where the user can enter their personal preferences 13 e.g., They may want to focus on improving their credit score or they may choose to focus on minimizing their monthly bill or maximize airline mileage. An additional feature that uses your smart phones Global Positioning System GPS allows the user to automatically prioritize a card selection based on location. In setting up the App they may also be given the ability to choose the manner in which they enter the data automatically 14 or manually 15 depending on the online availability of the data of their respective credit cards. After the data has been entered, the user can use the App to help them select a card 16 based on their preferences or they can choose to override and manually choose their card. Once a card has been selected a purchase 17 can be made. After the purchase has been made the App can be setup to lock the card 18 to prevent someone from hacking into the smart card, provided the smart card is equipped with this card locking feature.

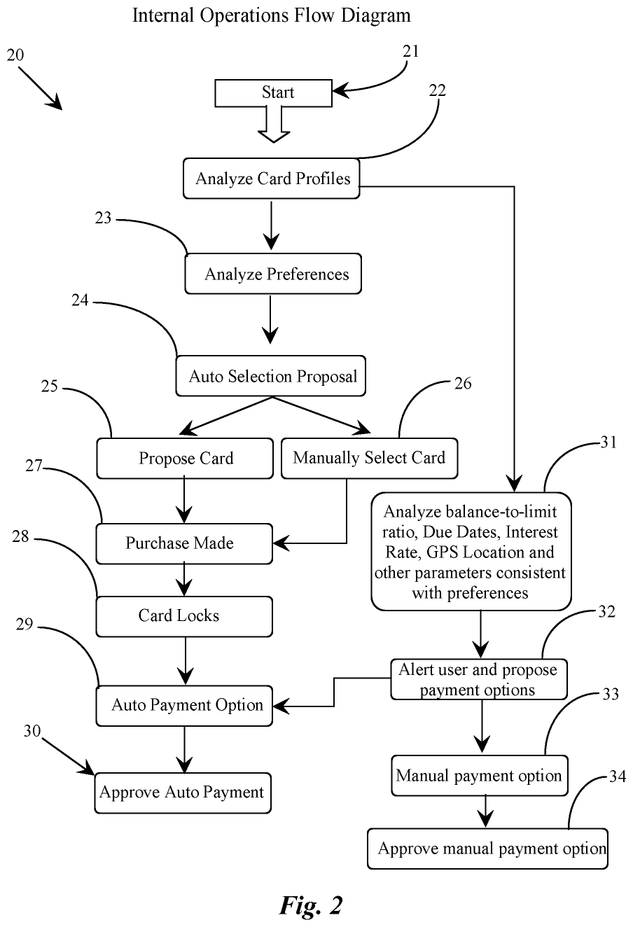

FIG. 2 Internal Operations Flow Diagram 20 describes the various operations that enable the user to benefit from the features built into the App. When the App is selected on the smart phone or the universal credit card the App analyzes card profiles 22, e.g., usage data, average balances, credit limits, airline mileage plans, Global Positioning System (GPS) Location. Then user preferences 23 are analyzed enabling 24 the auto card proposal to take place. The purpose of the GPS is in the event the individual uses a specific Card at a specific location the GPS feature will use this data in auto card selection. The user then has the option to accept the proposal 25 or manually 26 choose their card. The purchase 27 can then take place. Following the purchase the App can invoke the auto card lock feature 28, provided the universal card is equipped with this technology.

FIG. 2 has the elements as follows,

Element 21 is the start
Element 22 analyzes Card Profiles

### Element 23 Analyzes Preferences

Element 24 is an auto selection proposal. At this point the user can select a card proposed by the system or manually select card
Element 25 user chooses is proposed card
Element 24 purchase made
Element 28 is card locks
Element 29 presents an auto payment option
Element 30 is approve auto payment
Element 31 is an analytics engine using many parameters to analyzes the best card for the users transaction
Element 32 alerts user and proposes payment options
Element 33 is the manual payment option
Element 34 is the approve manual payment option
FIG. 2 has also describes a feature that automatically alerts user 32 when a payment is due or helps the user based 31 user preferences, card usage, balance-to-limit ratios and payment due dates. The payment proposal 32 and auto payment feature 29 and 30 is an important feature in helping the user build good credit and achieve their financial objects. To insure the user has the necessary flexibility to alter the auto payment feature the user will also be given the choice to override and choose the manual payment option 33 and 34. Note. Auto payment defaults are initially setup when setting up the preferences when the user sets up the application.

The alternative function of this smart phone App is to help the user automatically select the card that best reflects their values and goals whether they are using a universal card or they simply have multiple cards they can choose from. Once the App is invoked it will analyze multiple card features compared to the users previously selected preferences and then present the user with the recommended card to make their purchase. The user will then have the option to approve the selection or manually override it and select another card.

In addition to credit card selection for purchasing items there is also a user selectable feature offering prompts to remind the user to pay their credit card bill or user alert to pay down on credit when they exceed their debt load that may have a negative impact on their credit. This function is based on prior user-selected preferences. This auto payment alert feature may be enabled to easily and quickly transfer funds to pay a credit card bill or pay down available credit to insure the user does not exceed a balance-to limit ratio. At the time this document was drafted, a monthly average balance-to-limit ratio exceeding 30% would lower a credit score. The auto alert feature may also be user selectable. For example, the user may have the option to manually set the balance-to-limit ratio to 25% to give themselves a larger margin for improving their credit.

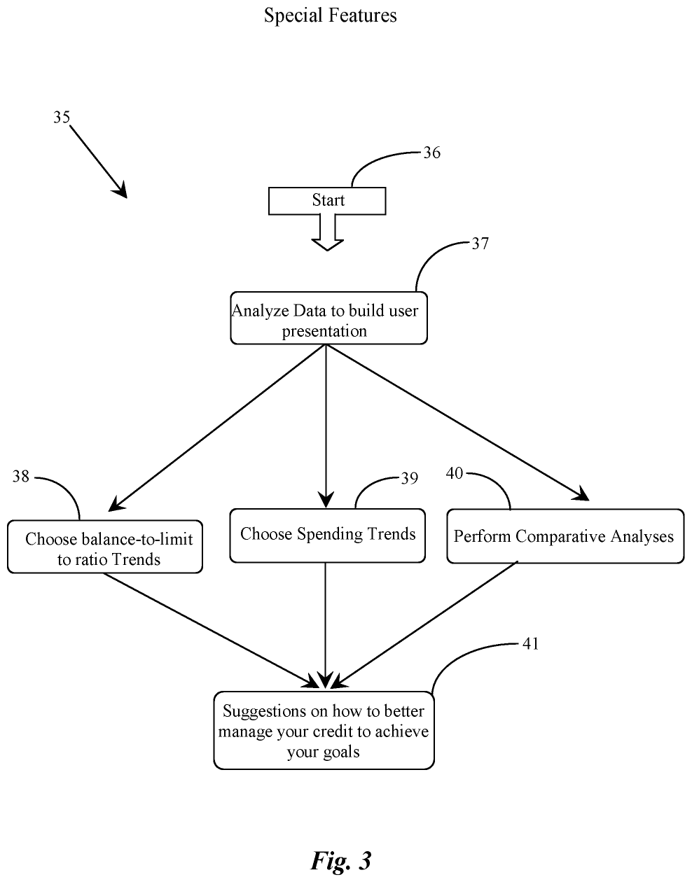

FIG. 3 is entitled “Special Features” This diagram 35 shows various features that help the user to analyze 37 and visualize trends e.g., Balance-to-limit trends 38, Spending trends 39 and comparative analyses 40 among other features that help the user better understand their finances. After the analysis has completed its function, it may offer suggestions 41 on what the user can do to more effectively achieve their objectives. The presentations can be in the form bar charts, line graphs or any other means that aids the user in better understanding their finances.

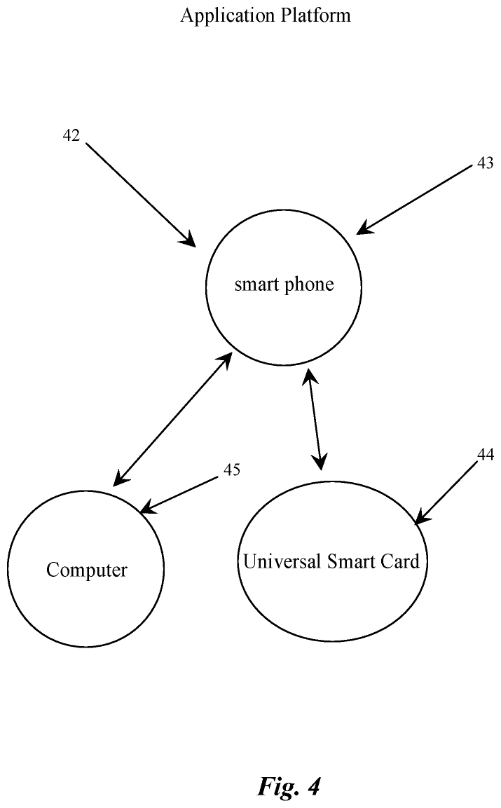

FIG. 4 Application Platforms 42 describes what platforms the App may run on. The primary use will be for a smartphone 43 to interact with universal smart card 44. However, the user may be given the option to setup and run the App on their computer 43. This feature will offer the user the ability to more conveniently set up preferences view the data and graphs resulting from the data analysis features described in FIG. 3. For individuals that do not use a computer, the App is also designed to operate independently of a computer.

The advantages of the present invention, is that it makes it significantly easier to manage credit or debit usage, either in the context of a universal credit or debit card technology or any device or computer that can support its operation. The App automatically calculates the best cards to use, when and how much the user should pay down their cards in order to maximize their credit score or any other priorities they may have selected when choosing their preferences.

While the foregoing written description of the invention enables one of ordinary Skill in software programming to make and use what is considered presently to be the best model thereof of one embodiment of the invention; those of ordinary skill in the field of software programming will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A system for choosing the right payment card during a transaction comprising:
a menu selection for a user to choose data that is automatically provided, user provided or manually entered data.

2. The System of claim 1 wherein the user preferences may be at least one of, card priorities, score optimization, payment maximization, cash back, bill payment sources and GPS location on or off.

3. The System of claim 1 wherein the auto entered data may be one of a credit limit, balance interest fees, cash back, airline points, gift cards, bill due dates, business or personal.

4. The System of claim 1 wherein the manual entered data may be one of a credit limit, balance interest fees, cash back, airline points, gift credits, bill due dates, business or personal.

5. The System of claim 1 wherein the auto entered data may be one of a credit limit, balance interest fees, cash back, airline points, gift cards, bill due dates, business or personal.

6. The System of claim 1 wherein any of the automatically entered data, the user preferences data or the manual entered data may help the user select the right card for the purchase at the right time.
